(19) United States
(12) Patent Application Publication
(10) Pub. No.: US 2021/0124969 A1
(43) Pub. Date: Apr. 29, 2021

(54) PLANAR AND/OR UNDISTORTED TEXTURE IMAGE CORRESPONDING TO CAPTURED IMAGE OF OBJECT

(71) Applicant: Spot Vision LLC, Portland, OR (US)

(72) Inventor: Joshua Victor Aller, Portland (97)

(21) Appl. No.: 17/079,664

(22) Filed: Oct. 26, 2020

Related U.S. Application Data
(60) Provisional application No. 62/926,637, filed on Oct. 28, 2019.

(51) Int. Cl. G06K 9/32; G06K 9/18; G06N 3/04

(52) U.S. Cl. CPC G06K 9/3275; G06K 9/3208; G06K 2009/363; G06N 3/04; G06K 9/183

(57) ABSTRACT

An image of an object captured by a camera includes a surface that corresponds to a non-planar surface of the object and/or that has distortions introduced by a three-dimensional (3D) perspective of the camera relative to the object during image capture. Pose parameters are determined from the captured image by using a machine learning model. Image space 2D coordinates that planarize and/or undistort the surface of the captured image are determined based on the pose parameters, a parameterized surface model definition, and camera properties. The image is interpolated using the image space 2D coordinates to produce a texture image corresponding to the captured image and including a surface that corresponds to the surface of the captured image but that is planar and/or undistorted.

### RELATED APPLICATIONS

This application claims priority to the provisional patent application filed on Oct. 28, 2019, and assigned U.S. provisional patent application No. 62/926,637, which is hereby incorporated by reference. This application is related to US issued U.S. Pat. No. 9,002,062, which also is hereby incorporated by reference.

### BACKGROUND

Printed media that include text, images, and/or digital codes, such as barcodes like Quick Response (QR) codes, are ubiquitous in the modern world. Two-dimensional (2D) printed media are often affixed to the three-dimensional (3D) packaging for products like medicine bottles, as well as to the 2D flat surfaces of identification cards, signage, and so on. 3D objects may also have such text, images, and digital codes directly printed, etched, etc., on them. Other 2D printed media, including magazines and brochures, have malleable surfaces for easier handling, which can result in curved surfaces during handling. Furthermore, even rigid 2D printed media may, when digitally captured as images using cameras, be geometrically distorted within the images, resulting from the 3D perspectives at which the cameras captured the images.

### BRIEF DESCRIPTION OF THE DRAWINGS

FIGS. 1A and 1B are diagrams depicting example digitally captured images having distorted and non-planar surfaces and corresponding example texture images having corresponding undistorted and planar surfaces.

FIG. 2 is a flowchart of an example process for planarizing and undistorting a surface of a digitally captured image.

FIG. 3 is a flowchart of an example process for generating image space two-dimensional (2D) coordinates for usage within the process of FIG. 2.

FIGS. 4A and 4B are flowcharts of example processes for generating uv minima and maxima for a cylindrical surface and a planar surface, respectively, for usage within the process of FIG. 3.

### DETAILED DESCRIPTION

As noted in the background, two-dimensional (2D) printed media that include text, images, and/or barcodes may be attached to three-dimensional (3D) objects, or the 3D objects may have such text, images, and digital codes directly imparted to or on them. Other 2D printed media can lack rigidity, resulting in their having curved surfaces when handled and thus effectively become 3D objects. Rigid 2D printed media that retain flattened surfaces when handled, and which are another type of object, may nevertheless become distorted within digitally captured images.

Humans are easily able to process the distortions introduced by 3D perspective and the mapping of 2D information onto 3D curved surfaces. For instance, it is trivial for humans to read text or interpret an image on a curved 3D surface or a 2D surface that is distorted as a result of the 3D perspective at which the 2D surface is being viewed. However, computing devices can have difficulty analyzing information presented on curved 3D surfaces or on distorted 2D surfaces within digitally captured images.

For example, a computing device like a smartphone, drone, autonomous or other vehicle, and so on, can include a camera that may digitally capture an image of an object having a curved or flat surface that is distorted due to the vantage point of the smartphone relative to the object during image capture. The computing device may attempt to analyze information on the object within the captured image, or may transmit the captured image to another computing device for such analysis. The analysis can be as varied as object recognition or identification, textual optical character recognition (OCR), watermark detection, barcode scanning, and so on. The curved and/or distorted nature of the object surface within the image can inhibit accurate information analysis.

As to watermark detection, a watermark can be considered as data embedded within an image in a visually imperceptible manner. For example, the image may be modified in image space to embed data within the image, by modifying certain pixels of the image in specified ways, where the pixels that are modified and/or the ways in which the pixels are modified correspond to the embedded data. As another example, the image may be transformed into the frequency domain using a fast Fourier Transform (FFT) or in another manner, and then modified in the frequency domain to embed data within the image. The resulting modified image is then transformed back to the image space.

As to barcode scanning, a barcode can be considered a visually discernible but machine-readable code. The barcode may be a one-dimensional (1D) barcode in the form of a pattern of lines of varying widths. The barcode may instead be a 2D, or matrix, barcode that includes rectangles, dots, hexagons and other geometric patterns over two dimensions. One example of a 2D barcode is a Quick Response (QR) code.

Techniques described herein planarize (i.e., flatten) and/or undistort an object surface within a digitally captured image. Therefore, subsequent analysis of information contained or presented on the object surface can be more accurately performed. The techniques described herein produce a texture image corresponding to a digitally captured image of an object. The digitally captured image includes an object surface that is non-planar (e.g., curved) and/or which may have distortions introduced by the 3D perspective of a camera relative to the object during image capture. The texture image, by comparison, has a corresponding object surface that is planar (i.e., flattened) and/or that is undistorted.

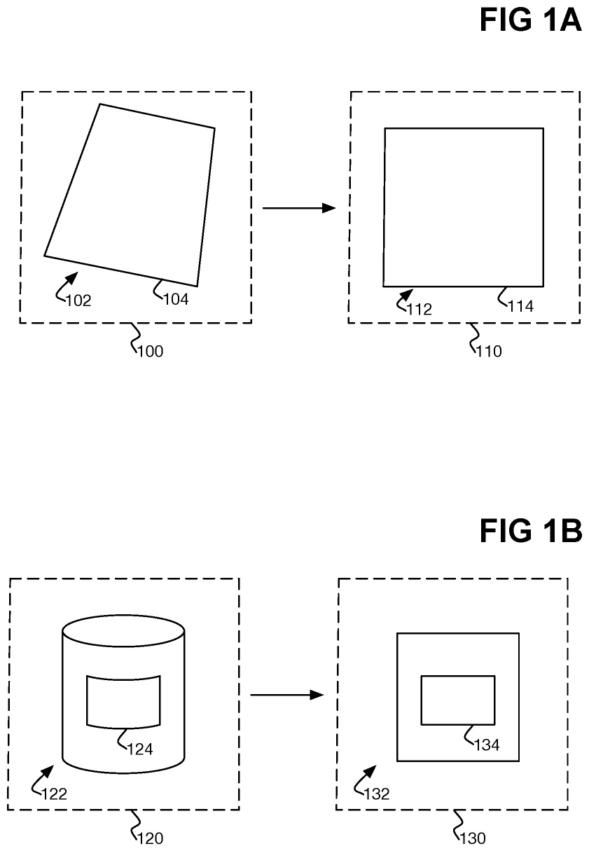

FIGS. 1A and 1B show example undistortion and planarization of a distorted planar surface and a non-planar surface, respectively. In FIG. 1A, a digitally captured image 100 includes an object 102 and has a planar surface 104. However, the planar surface 104 is distorted within the image 100, such as due to the 3D perspective of a camera relative to the object 102 during image capture. The techniques described herein produce a texture image 110 corresponding to the image 100. The texture image 110 can include an object 112 that corresponds to the object 102, and has a planar surface 114 corresponding to the planar surface 104 but that is undistorted. The techniques thus undistort the surface 104 of the image 100.

In FIG. 1B, a digitally captured image 120 includes an object 122 having a cylindrical surface 124. The cylindrical surface 124 may or may not be distorted within the image 120. The techniques described herein produce a texture image 130 corresponding to the image 120. The texture image 130 can include an object 132 that corresponds to the object 122, and includes a surface 134 corresponding to the cylindrical surface 124 but that is planar (and which is further undistorted, particularly if the cylindrical surface 124 is distorted). The techniques thus planarize (and can further undistort) the cylindrical surface 124 of the image 120.

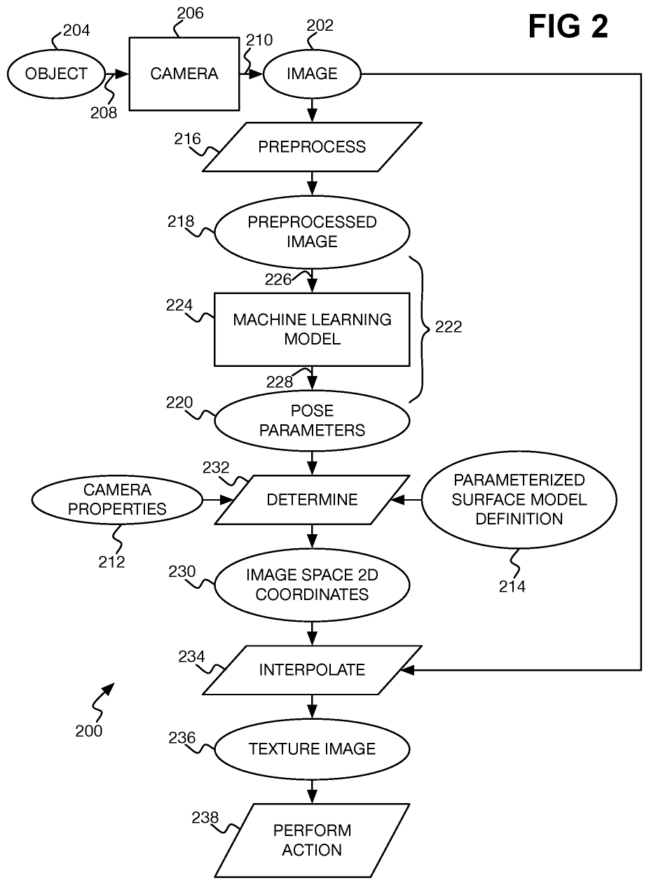

FIG. 2 shows an example process 200 for planarizing and undistorting a surface of a digitally captured image. The process 200 can be implemented as program code stored on a non-transitory computer-readable data storage medium and executable by one or multiple processors of one or multiple computing devices. For example, one computing device may perform the entirety of the process 200, or different computing devices may perform different parts of the process 200.

An image 202 of an object 204 digitally captured in 3D space by a camera 206 (208) is received (210). The camera 206 may be part of the computing device performing the process 200, in which case a processor of the computing device receives the digitally captured image 202 from the camera 206. The camera 206 may instead be part of a different computing device than that performing the process 200, in which case the computing device performing the process 200 may receive the digitally captured image 202 from the computing device of which the camera 206 is a part, such as over a network like the Internet.

The object 204 has a non-planar or planar surface. The digitally captured image 202 therefore has a corresponding surface that is non-planar and/or that has distortions introduced by a 3D perspective of the camera 206 relative to the object 204 during image capture. For example, the image 202 may have an undistorted non-planar surface, a distorted non-planar surface, or a distorted planar surface. An example of a non-planar surface is a cylindrical surface, but the techniques described herein are applicable to other types of non-planar surfaces as well.

The image 202 may be preprocessed (216) to produce a corresponding preprocessed image 218. For example, the image 202 may be preprocessed by downscaling the resolution of the captured image 202. Pose parameters 220 are determined (222) from the image 202, such as from the preprocessed image 218, by using a machine learning model 224. For instance, the preprocessed image 218 may be input into the machine learning model 224 (226), with the pose parameters 220 provided as output from the model 224 (228). The machine learning model 224 may be applied or executed by the computing device performing the process 200 or by a different computing device, in which case the former device transmits the image 202 or the preprocessed image 218 to the latter device, and the latter device transmits the pose parameters 220 or the planarized texture image 236 back to the former device.

The image 202 may therefore be preprocessed to match the input requirements of the machine learning model 224. For example, the machine learning model 224 may require an image having a specific resolution with color values provided for specific color channels, such as red, green, and blue (RGB) color channels. The machine learning model 224 may be a neural network or another type of machine learning model. An example of a neural network is a residual neural network (ResNet).

The pose parameters 220 specify the pose of the object 204 within the captured image 202. The pose of the object 204 is the 3D spatial position and orientation of the object 204 relative to a reference camera. For example, a 3D pose can be fully described with six degrees of freedom using rotate-x, rotate-y, rotate-z, translate-x, translate-y, and translate-z parameters. The rotate-x, rotate-y, and rotate-z parameters specify the rotation of the object 204 about the x, y, and z directional axes, respectively. The translate-x, translate-y, and translate-z parameters specify the translation of the object 204 along the x, y, and z directions, respectively.

For some types of parametric surfaces, just a subset of the six pose parameters may have to be determined to specify a surface that mirrors the distortions of the surface within the image 202. For example, the distortions of an infinite plane appear identical to a reference camera regardless of the translation of the plane. To remove the distortions from the image 202 of such a plane, just the three rotational parameters are sufficient. The translate-x and translate-y parameters may therefore be set to zero, while the translate-z parameter set to a fixed non-zero value to specify an arbitrary distance between the reference camera and the plane.

As another example, distortions of an infinitely tall cylinder of any radius can be mirrored with just four pose parameters. Because the cylinder's axis of symmetry is aligned with the y-axis in its model space, the rotate-y parameter does not provide additional information as to the shape of the cylinder. As such, just the rotate-x and rotate-z parameters have to be specified. Similarly, the translate-y parameter does not provide additional information because the cylinder is infinitely tall, such that just the translate-x and translate-z parameters may have to be specified. The translate-y and rotate-y parameters may be set to zero, therefore. Distance to the cylinder and the radius of the cylinder will be the same in the image 202, and therefore just the described four parameters have to be specified.

The machine learning model 224 may be trained by using a labeled dataset of images with corresponding pose parameters and captured with a camera that is considered the reference camera. In cases in which just rotation pose parameters are required, such as in the case of planar surfaces, a gyroscope or other angular measurement device may be employed to determine the rotational parameters associated within the training images. For cases in which translation values are also necessary, such as in the case of non-planar surfaces, robotic placement or translational and angular measurement systems can be utilized to determine both the rotational and translational parameters. Training images may also be synthesized using computer graphics techniques, in which case the pose parameters are identical to those input to the image synthesis. Images may be scaled and cropped to match the input resolution of the machine learning model 224.

An optimizer, such as a network optimizer in the case of a neural network, can then minimize a loss function based on pose parameters. Examples of network optimizers include the stochastic gradient descent (SGD), Adam, and AdaGrad network optimization techniques. One example of a loss function for training a neural network for plane pose parameters is:

$$loss = {\sum }_{i = 1}^{n} {( {rx}_{i} - rx {label}_{i} )}^{2} + {( r {y}_{i} - {rylabel}_{i} )}^{2} + {( r {z}_{i} - {rzlabel}_{i} )}^{2} ,$$

where rx, ry, and rz are the output of the neural network, and rxlabel, rylabel, and rzlabel are the rotation pose parameters describing the pose of each object i in a batch of n training images.

For pose parameters associated with non-planar surfaces, where translation values also have to be provided, a loss function may include a weight K that determines how much to scale the difference in translation parameters versus rotation parameters. An example of a loss function for training a neural network for pose parameters for an (infinitely tall) cylinder is:

$$loss = {\sum }_{i = 1}^{n} {( {rx}_{i} - {rxlabel}_{i} )}^{2} + {( {rz}_{i} - {rzlabel}_{i} )}^{2} + K [ {( t {x}_{i} - {txlabel}_{i} )}^{2} + {( t {z}_{i} - {tzlabel}_{i} )}^{2} ] ,$$

where rz, rx, tx, and tz are the output of the neural network. Further, rxlabel and rzlabel are the rotational pose parameters and txlabel and tzlabel are the translational pose parameters describing the pose of each object i in a batch of n training images. Machine learning model training can be performed in batches of labeled images, using a selected optimization technique, until a selected loss function is minimized as desired.

Image space 2D coordinates 230 are determined (232) based on the pose parameters 220, camera properties 212, and a parameterized surface model definition 214. One particular example technique for determining the image space 2D coordinates 230 is described later in the detailed description. A parametric surface is a surface in Euclidean space, which may be defined by a parametric equation with two parameters u, v. Examples of a parametric surface include a planar surface, as well as non-planar surfaces such as a cylindrical surface, a conic surface, a parabolic surface, or a network of bicubic patches.

The image space 2D coordinates 230 are coordinates within a 2D image space that correspond to the surface of the image 202 as planarized and undistorted. That is, the image space 2D coordinates 230 correspond to the locations within the image 202 that are sampled to determine the planarized and undistorted texture image 236. The 2D image space is a 2D Cartesian space for which any coordinate with components within the range (−1, 1) refers to the interpolation of color values from neighboring pixels in the image 202.

The camera properties 212 are intrinsic properties of a reference camera that define a mathematical function of projection from 3D camera space to the 2D image space, or from which this mathematical function can be defined. The reference camera may be the actual camera used to capture the training images used to train the machine learning model 224. The 3D camera space is a 3D space in which the camera 206 is at the origin of Cartesian space with the viewing direction along the negative z-axis. The camera properties 212 correspond to the camera 206 in that the properties of the camera 206 may distort the camera properties 212 of the reference camera. Stated another way, the camera properties 212 correspond to the camera 206 in that the camera properties 212 specify the properties of the camera 206 in undistorted form. As one example, the camera 206 may have a wider or narrower field of view than the reference camera.

Using camera projection, points in the 3D camera space can be converted to 2D image space. For example, for an ideal camera that is the reference camera, projection may be simplified to image_x=camera_x/camera_z and image_y=camera_y/camera_z, where image_x and image_y are the x and y 2D image space coordinates corresponding to the projection of the camera 206 at x, y, and z 3D camera space coordinates of camera_x, camera_y, and camera_z. Similarly, using inverse projection points in the 2D image space can be converted to rays in the 3D camera space. Ray projection is the pseudo-inverse of camera projection, and translates from 2D image space to 3D camera space at a unit z-depth.

The planar or non-planar surface of the object 204 within the digitally captured image 202 in undistorted form can be considered a parametric surface, which is further a surface in a 3D Euclidean space and that is mathematically formulated as a function of two parameters like u, v. These parameters exist in 2D parameter space, may be bounded or unbounded, and may be cyclical or non-cyclical. The 2D parameter space may be converted to 3D model space via evaluation of the parametric surface in 3D model space, which is the 3D space in which the parametric surface of the image 202 is constructed. For convenience, the 2D parametric space may be centered on the origin of and aligned with axes of the 3D model space.

The parameterized surface model definition 214 specifies an ideal surface, which may but does not have to correspond to the surface within the captured image 202, based on parameters in the 2D parameter space. In the case in which the ideal surface corresponds to the surface within the captured image 202, the ideal surface is the surface within the captured image 202 in undistorted form, in other words. For example, a plane (e.g., rectangle) based on u, v parameterization in the 2D parameter space can be modeled as x=u, y=v, and z=0 in the 3D model space. A cylinder based on u, v parameterization in the 2D parameter space can be modeled as x=cos(u), y=v, and z=sin(u) in the 3D model space.

These 3D parameterized surfaces can be constructed in the 3D model space, and then transformed or converted to the 3D camera space (or another 3D real world space) by usage of a pose matrix generated from the pose parameters 220. For example, the pose matrix may be generated from six pose parameters 220 (e.g., rotate-x, rotate-y, rotate-z, translate-x, translate-y, and translate-z parameters) by converting these pose parameters 220 to a 4×4 transformation matrix. Points in 3D camera space or another 3D real world space can similarly be converted to 3D model space using an inverse pose matrix.

The image 202 is interpolated (234) using the image space 2D coordinates 230 to generate a texture image 236 including a surface that corresponds to the non-planar and/or distorted surface of the captured image 202 but that is planar and/or undistorted. The texture image 236 is represented as an array of color values, such as red, green, and blue (RGB) color values, which are each associated with a pixel of the image 202. The image space 2D coordinates 230 are thus used to interpolate (234) the full resolution digitally captured image 202 to produce a 2D array of color values that constitutes the (recovered) texture image 236.

The color values of the image 202 can be interpolated between pixels, such as in a bilinear or bicubic manner, to produce a continuous function that can be sampled by image space 2D coordinates. As such, the texture image 202 can be evaluated as a continuous function color=image(u, v), where u and v are the two components of the 2D image space. U and v may range from (−1, −1) to (1, 1) with all values inside the textured image 236.

Any information presented in or on the non-planar and/or distorted surface of the captured image 202 is more easily analyzed in or on the corresponding planar and/or undistorted surface of the corresponding texture image 236. As such, an action may be performed (238) in relation to the object 204 within the image 202 based on the texture image 236. For example, OCR may be performed on the texture image 236, or a watermark may be detected within the texture image 236. As other examples, a barcode may be detected within the texture image 236, or the object 204 may be identified (i.e., recognized) by performing suitable image processing (e.g., object recognition) on the texture image 236.

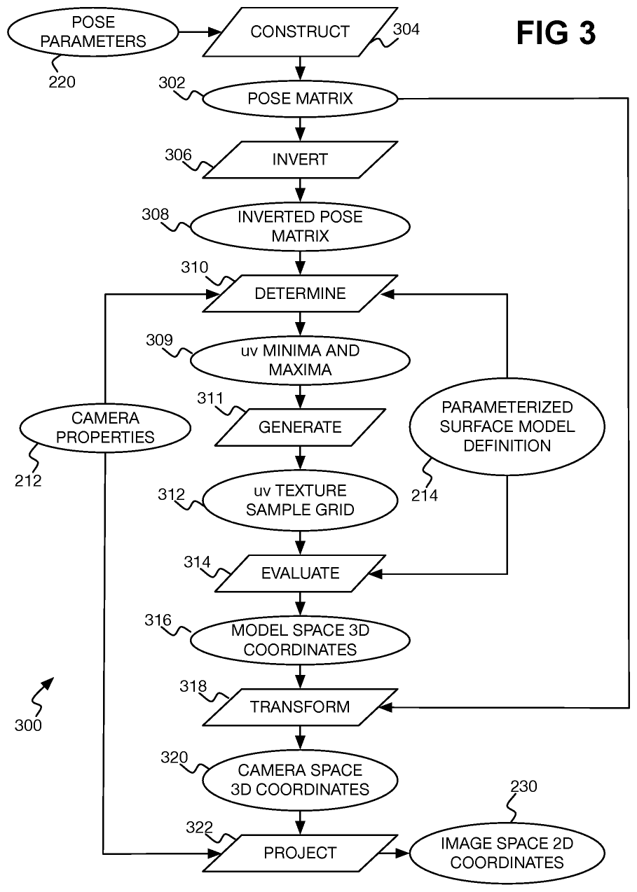

FIG. 3 shows an example process 300 to determine the image space 2D coordinates 230 based on the pose parameters 220, the camera properties 212, and the parameterized surface model definition 214 in (232) of FIG. 2. A pose matrix 302 is constructed from the pose parameters 220 (304). As noted, the pose matrix 302 may be generated from six pose parameters 220 (e.g., rotate-x, rotate-y, rotate-z, translate-x, translate-y, and translate-z parameters) by converting these pose parameters 220 to a 4×4 transformation matrix.

In the case of a planar surface, translation values may not be output from the machine learning model 224. The translate-x and translate-y parameters are set to zero, and the translate-z parameter is fixed at an arbitrary depth to move the plane in front of the camera. Similarly, in the case of a cylindrical surface, not all pose parameters may be output from the machine learning model 224. The rotate-y parameter is set to zero because a cylinder is invariant to rotation about its axis, and the translate-y parameter is also set to zero when considering an infinitely tall cylinder.

The pose matrix 302 is inverted (306) to produce an inverted pose matrix 308. Uv minima and maxima 309 are determined (310) based on the inverted pose matrix 308, the camera properties 212, and the parameterized surface model definition 214. It is noted that if the machine learning model 224 of FIG. 2 instead outputs parameters 220 for an inverse pose, then the uv minima and maxima 309 are generated based on the pose matrix 302 constructed from such (inverted) pose parameters 220 instead of based on the inverted pose matrix 308.

The uv minima and maxima 309 define a range of u and v values that span the visible range of the surface specified in the parameterized surface model definition 214. This uv minima and maxima 309 (i.e., the range of u and v values that span the visible range of the surface specified in the parameterized surface model definition 214) can be determined in a number of different ways. Two particular example techniques for determining the uv minima and maxima 309 are described later in the detailed description. The first example technique is for producing the uv minima and maxima 309 for a planar surface, and the second example technique is for producing the uv minima and maxima 309 for a cylindrical surface.

However, generally for any parameterized surface, the uv minima and maxima 309 may as one example be generated by first randomly or otherwise generating rays within the camera view frustum specified by the camera properties 212. The rays are intersected with the surface specified by the parameterized surface model definition 214 to determine u, v parameters of the intersection points. This range of u, v parameters specifies the range of parameterization of the visible portion of the surface specified in the parameterized surface model definition 214, and thus corresponds to the uv minima and maxima 309.

As another example, the surface specified by the parameterized surface model definition 214 may be trimmed by planes of the view frustum specified by the camera properties 212. The surfaces are further trimmed to just the portions having normal facing the camera eye point specified by the properties 212. The range of parameterization of this visible portion of the surface thus corresponds to the uv minima and maxima 309.

As a third example, randomly or otherwise generated u, v model parameter coordinates can be generated. Any coordinates having an associated surface normal that does not face the camera eye point specified by the camera properties 212 are excluded, as are any coordinates with points projecting outside the camera field of view specified by the properties 212. The range of remaining u, v parameter values corresponds to the uv minima and maxima 309. In any of these examples, padding may be added to the smaller of the u or v range to make the u value range (e.g., defined as u_minimum to m_maximum) equal to the v value range (e.g., defined as v_minimum to v_maximum).

A uv texture sample grid 312 is generated (311) based on the uv minima and maxima 309. The uv texture sample grid 312 can be structured as a two-dimensional array of uv pairs. Each row is fixed in the v parameter, with the u parameter increasing uniformly from u_minimum at left to u_maximum at right. Each column is fixed in the u parameter, with the v parameter increasing uniformly from v_minimum at bottom to v_maximum at top.

The parameterized surface model definition 214 is evaluated (314) at each point of the uv texture sample grid 312 to produce model space 3D coordinates 316. The model space 3D coordinates 316 are transformed (318) using the pose matrix 302 to produce camera space 3D coordinates 320. It is noted that if the machine learning model 224 of FIG. 2 instead outputs parameters 220 for an inverse pose, then the model space 3D coordinates 316 are transformed using the inverted pose matrix 308 instead of the pose matrix 302 constructed from such (inverted) pose parameters 220. The camera space 3D coordinates 320 are projected (322) using the camera properties 212 to produce image space 2D coordinates 230.

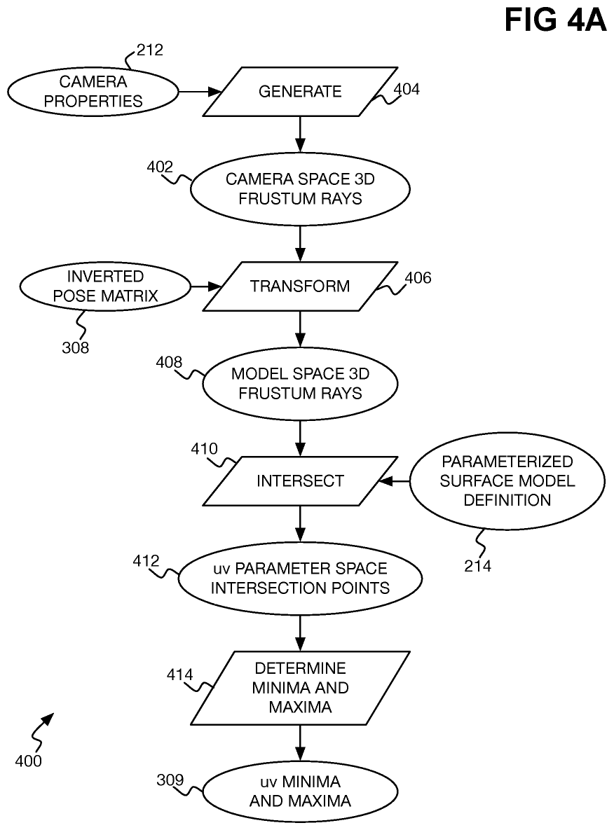

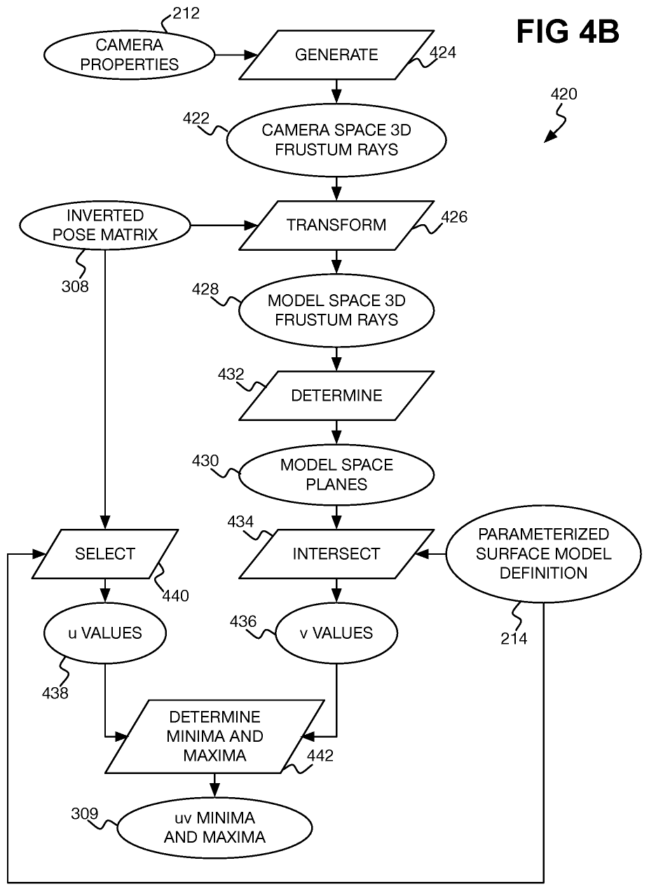

FIG. 4A shows an example process 400 to determine the uv minima and maxima 309 in (310) of FIG. 3 for a parametric surface that is a planar surface (i.e., a plane). Four camera space 3D frustum rays 402 are generated (404) using the camera properties 212, one at each corner of the camera view frustum. The frustum rays 402 thus correspond to the corners of the projection from the origin in 3D camera space. The camera space 3D frustum rays 402 are then transformed (406) using the inverted pose matrix 308 to produce model space 3D frustum rays 408. It is noted that if the machine learning model 224 of FIG. 2 instead outputs parameters 220 for an inverse pose, then the transformation uses the pose matrix 302 constructed from such (inverted) pose parameters 220 instead of the inverted pose matrix 308.

The model space 3D frustum rays 408 are intersected (410) with the parameterized surface model definition 214 to produce uv parameter space intersection points 412. The uv parameter space intersection points 412 represent the u, v coordinates of the parameterized surface model definition 214 at the locations where the model 214 intersects the model space 3d frustum rays 408. Minima and maxima of the intersection points 412 are determined (414) to produce the uv minima and maxima 309.

FIG. 4B shows an example process 420 to determine the uv minima and maxima 309 in (310) of FIG. 3 for a parametric surface that is a cylindrical surface (i.e., a cylinder, such as one that is infinitely tall, or a section thereof). Camera space 3D frustum rays 422 corresponding to the edges of the camera view frustum are generated (424) using the camera properties 212, as in FIG. 4A. The camera space 3D frustum rays 422 are then transformed (426) using the inverted pose matrix 308 to produce model space 3D frustum rays 428, also as before. It is thus again noted that if the machine learning model 224 of FIG. 2 instead outputs parameters 220 for an inverse pose, then the transformation uses the pose matrix 302 constructed from such (inverted) pose parameters 220 instead of the inverted pose matrix 308.

Model space planes 430 are determined (432) using the model space 3D frustum rays 428. For example, if there are four frustum rays 428, then four model space planes 430 are determined, with each plane 430 defined as the plane including two adjacent rays 428. The model space planes 430 are intersected (434) with the parameterized surface model definition 214 to produce v values 436. The v values represent the range of the visible portion of the cylindrical surface along the v parameter.

By comparison, u values 438 representing the range of the visible portion of the cylinder along the u parameter are selected (440) from the parameterized surface model definition 214 using the inverted pose matrix 308. More specifically, the u values 438 are those in which a normal vector to the cylindrical surface has a negative dot product with a vector extending from the eye point of the camera 206 to a corresponding location of the cylindrical surface for the u parameter. The cylindrical surface faces the camera 206 along this range of u values 438.

It is noted that if the machine learning model 224 of FIG. 2 instead outputs parameters 220 for an inverse pose, then the u values 438 are selected using the pose matrix 302 constructed from such (inverted) pose parameters 220 instead of the inverted pose matrix 308. The u values 438 and the v values 436 may be considered as constituting a parameter space uv grid. Minima and maxima of the u values 438 and the values 436 are determined (442) to produce the uv minima and maxima 309.

The techniques that have been described can planarize (i.e., flatten) a curved surface (e.g., a cylindrical surface) within a digitally captured image, planarize and undistort a curved surface within a captured image, and undistort a planar surface within an image. Subsequently performed actions on information contained or presented within the planarized and/or undistorted surface can thus yield more accurate results. For example, OCR, watermark detection, and/or object identification or recognition can effectively become more accurate, such that the described techniques can improve these analyses as well as other types of actions that may be performed on the basis of surfaces captured within images.

We claim:

1. A method comprising:
receiving, by a processor, an image of an object captured by a camera, wherein the captured image includes a surface that corresponds to a non-planar surface of the object and/or that has distortions introduced by a three-dimensional (3D) perspective of the camera relative to the object during image capture;
determining, by the processor, pose parameters from the captured image by using a machine learning model;
determining, by the processor, a plurality of image space 2D coordinates that planarize and/or undistort the surface of the captured image, based on the pose parameters, a parameterized surface model definition, and camera properties; and
interpolating, by the processor, the image using the image space 2D coordinates to produce a texture image corresponding to the captured image, wherein the texture image includes a surface that corresponds to the surface of the captured image but that is planar and/or undistorted.

2. The method of claim 1, further comprising:
performing, by the processor, preprocessing on the captured image, wherein the preprocessed captured image is provided as input to the machine learning model and the pose parameters is received as output from the machine learning model.

3. The method of claim 2, wherein performing the preprocessing on the capture image comprises:
downscaling a resolution of the captured image.

4. The method of claim 1, wherein the machine learning model comprises a neural network.

5. The method of claim 1, wherein determining the image space 2D coordinates comprises:
constructing a pose matrix from the pose parameters;
determining uv minima and maxima based on the pose matrix, the parameterized surface model definition, and the camera properties; and
generating a uv texture sample grid based on the uv minima and maxima, wherein the uv texture sample grid comprises a plurality of points.

6. The method of claim 5, wherein constructing the pose matrix comprises:
constructing an initial pose matrix from the pose parameters; and
inverting the initial pose matrix to produce the pose matrix.

7. The method of claim 5, wherein determining the image space 2D coordinates further comprises:
evaluating the parameterized surface model definition at each point of the uv texture sample grid to generate a corresponding plurality of model space 3D coordinates;
transforming the model space 3D coordinates using the pose matrix to produce a corresponding plurality of camera space 3D coordinates; and
projecting the camera space 3D coordinates using the camera properties to produce the image space 2D coordinates.

8. The method of claim 7, wherein transforming the model space 3D coordinates using the pose matrix comprises:
transforming the model space 3D coordinates using an inverted pose matrix of the pose matrix.

9. The method of claim 5, wherein the surface corresponds to a planar surface of the object.

10. The method of claim 9, wherein determining the uv minima and maxima based on the pose matrix, the parameterized surface model definition, and the camera properties comprises:
generating a plurality of camera space 3D frustum rays using the camera properties;
transforming the 3D frustum rays using the pose matrix to produce a corresponding plurality of model space 3D frustum rays;
determining intersections of the model space 3D frustum rays with the parameterized surface model definition to produce a corresponding plurality of uv parameter space intersection points; and
determining minima and maxima of the uv parameter space intersection points.

11. The method of claim 10, wherein transforming the 3D frustum rays using the pose matrix comprises:
transforming the 3D frustum rays using an inverted pose matrix of the pose matrix.

12. The method of claim 5, wherein the surface corresponds to a cylindrical surface of the object.

13. The method of claim 12, wherein determining the uv minima and maxima based on the pose matrix, the parameterized surface model definition, and the camera properties comprises:
generating a plurality of camera space 3D frustum rays using the camera properties;
transforming the 3D frustum rays using the pose matrix to produce a corresponding plurality of model space 3D frustum rays;
determining a plurality of model space planes using the 3D frustum rays;
determining intersections of the model space planes with the parameterized surface model definition to produce v values;
selecting u values of the parameterized surface model definition using the pose matrix; and
determining minima and maxima of the produced v values and the selected u values.

14. The method of claim 13, wherein transforming the 3D frustum rays using the pose matrix comprises:
transforming the 3D frustum rays using an inverted pose matrix of the pose matrix.

15. The method of claim 13, wherein selecting the u values of the parameterized surface model definition using the pose matrix comprises:
selecting the u values of the parameterized surface model definition using an inverted pose matrix of the pose matrix.

16. The method of claim 13, wherein selecting the u values of the parameterized surface model definition comprises:
identifying a range of the u values in which a normal vector to the cylindrical surface has a negative dot product with a vector extending from an eye point of the camera to a corresponding location of the cylindrical surface.

17. The method of claim 1, further comprising:
performing an action in relation to the object within the captured image based on the texture image corresponding to the captured image.

18. The method of claim 1, wherein performing the action in relation to the object within the captured image based on the texture image corresponding to the captured image comprises:
performing optical character recognition (OCR) on the texture image.

19. The method of claim 1, wherein performing the action in relation to the object within the captured image based on the texture image corresponding to the captured image comprises:
detecting a watermark within the texture image.

20. The method of claim 1, wherein performing the action in relation to the object within the captured image based on the texture image corresponding to the captured image comprises:
decoding a barcode within the texture image.

21. The method of claim 1, wherein performing the action in relation to the object within the captured image based on the texture image corresponding to the captured image comprises:
identifying the object within the captured image by performing image processing on the texture image.
